(19) United States
(12) Patent Application Publication
(10) Pub. No.: US 2006/0048128 A1
(43) Pub. Date: Mar. 2, 2006

(54) Module preparation scripts

(76) Inventors: Steven T. Roth, Sunnyvale, CA (US); C.P. Vijay Kumar, Sunnyvale, CA (US); Harish S. Babu, Santa Clara, CA (US); Zheng Zhang, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/931,720

(22) Filed: Sep. 1, 2004

(51) Int. Cl. G06F 9/44

(52) U.S. Cl. 717/166; 717/162

(57) ABSTRACT

Systems, methods, and devices are provided for handling changes in module load status. One embodiment includes a module having an object file and a module preparation script. The module object file can implement a function in a program application. The module preparation script file can be associated with the module object file to provide information to prepare the program application for a change in the load status of the module.

### BACKGROUND

In a computing device, such as a server, router, desktop computer, laptop, etc., and other devices having processor logic and memory, the device includes an operating system and a number of application programs that execute on the computing device. The operating system and program applications are typically arranged in different layers of the device's computing structure. For example, many computing devices include an operating system layer and an application layer to enable the device to perform various tasks.

The operating system layer includes a “kernel”. The kernel is a master control program that runs the computing device. The kernel provides functions such as task, device, and data management, among others.

The application layer includes application programs that perform particular tasks. These programs can typically be added by a user or administrator as options to a computer device. Application programs are executable instructions, which are located above the operating system layer and accessible by a user.

The application layer and other user accessible layers are often referred to as being in “user space”, while the operating system layer can be referred to as “kernel space”. As used herein, user space, or “user-mode” implies a layer of code which is more easily accessible to a user or administrator than the layer of code which is in the operating system layer or kernel space.

In software development, code is typically written in a human readable format and translated into a machine readable format called machine language. For example, software is often written in source code and translated by a compiler into object code. Object code is a machine language format code that uses strings of zeros and ones to communicate computer executable instructions to the computing device. Source code is human readable code that is easier for humans to understand than object code.

Additionally, software code can be developed in parts to allow for changes to be made to less than the entire program. These parts, also called modules, can later be combined to create a larger software program. A utility known as a “linker” can be used to combine all required machine language modules into an executable program that can run in the computer.

The function of linking modules can be accomplished at the time that the entire software program is compiled, or in some instances, can be performed at a later time, either when the software program is not executing, e.g., in a development environment or when it is executing, e.g., in a runtime environment. The process of linking a module at runtime is also referred to as loading a module. Modules can also be unloaded through an unlinking process, where a module is removed from a software application.

Runtime loading and unloading can be beneficial in computing systems and devices that should not experience periods of downtime, either when they are shut down or when programs are unavailable. This can be the case, for example, in enterprise computing devices and systems. In such devices and systems, it can be costly for a device, system, or functionality thereof to be unavailable. Another benefit is the ability for the device to reduce the amount of memory that is being used by programs not in use. This can be accomplished by unloading a program if it is not to be used in the near future. This frees up memory space for use by other program instructions.

In many instances, when modules are loaded or unloaded, the computing device or system has to be configured in a particular way in order for the module to load or unload correctly. For example, the module may have to seek access to other modules. The module may have to access data to be used with the module to be loaded. Or, the module may have to use program instructions to perform certain tasks related to the loading or unloading, or particular settings, such as tunables may have to be set correctly.

If these items are not accomplished as needed, such as before or after a module is loaded/unloaded, the loading or unloading of the module may not be fully accomplished. Such instances can leave the device or system in a situation where the module is partially loaded or partially unloaded.

### BRIEF DESCRIPTION OF THE DRAWINGS

FIG. 1 is a block diagram of an exemplary computer system suitable to implement embodiments of the invention.

FIG. 2 is a block diagram embodiment of an exemplary software system which can be executed on the computer system of FIG. 1.

FIG. 3 is a block diagram of an example of a software development system.

FIG. 4 is an illustration of a development environment module embodiment of the present invention.

FIG. 5 is an illustration of a target environment module embodiment of the present invention.

FIG. 6 is an example of a module and module preparation script interaction.

FIG. 7 illustrates a method embodiment for handling a change in module load status.

### DETAILED DESCRIPTION

Embodiments of the present invention provide methods, systems, and devices for handling a change in module load status. In various embodiments a module preparation script (or “modprep script”) is provided to prepare an operating system for the change in module load status.

Embodiments can include program instructions to provide information that can ensure that the operating system is ready for the loading or unloading of a module. Information can include, for example, information relating to whether program instructions, object code, or other modules are available. Information can also include finding and making such resources available. Information can also provide for the checking of an operating system setup to identify and/or edit system settings to be ready for the loading or unloading, and the like. Such information can be related to software, hardware, or both.

Additionally, program embodiments can allow a user, such as an administrator, to check or follow the status of the module preparation script and/or the loading or unloading of the module. Embodiments can also initiate and/or execute the module preparation script in a manner that is transparent to the user.

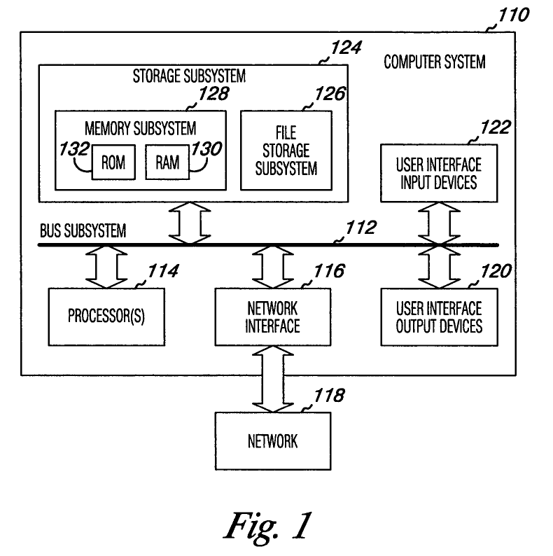

FIG. 1 is a block diagram of an exemplary computer system 110 suitable to implement embodiments of the invention. Computer system 110 includes at least one processor 114 which communicates with a number of other computing components via bus subsystem 112. These other computing components may include a storage subsystem 124 having a memory subsystem 126 and a file storage subsystem 128, user interface input devices 122, user interface output devices 120, and a network interface subsystem 116, to name a few. The input and output devices allow user interaction with computer system 110. Network interface subsystem 116 provides an interface to outside networks, including an interface to network 118 (e.g., a local area network (LAN), wide area network (WAN), Internet, and/or wireless network, among others), and is coupled via network 118 to corresponding interface devices in other computer systems. Network 118 may itself be comprised of many interconnected computer systems and communication links. Communication links as used herein may be hardwire links, optical links, satellite or other wireless communications links, wave propagation links, or any other mechanisms for communication of information.

User interface input devices 122 may include a keyboard, pointing devices such as a mouse, trackball, touchpad, or graphics tablet, a scanner, a touch screen incorporated into a display, audio input devices such as voice recognition systems, microphones, and other types of input devices. In general, use of the term “input device” is intended to include all possible types of devices and ways to input information into computer system 110 or onto computer network 118.

User interface output devices 120 may include a display subsystem, a printer, a fax machine, or non-visual displays such as audio output devices. The display subsystem may be a cathode ray tube (CRT), a flat-panel device such as a liquid crystal display (LCD) and/or plasma display, or a projection device (e.g., a digital light processing (DLP) device among others). The display subsystem may also provide non-visual display such as via audio output devices. In general, use of the term “output device” is intended to include all devices or components that output information from computer system 110 to a user or to a machine, including but not limited to computing devices and systems. User input and output devices can be used by a user, such as an administrator, to initiate a change in load status of a module. For example, the user can enter a command word such as “load” or “unload” which can indicate to the computing device that it is to initiate a load status change process.

Program instructions for conducting a load status change and the modules themselves, can be stored in memory accessible by the computing device or system. In some embodiments, the instructions and/or modules can be provided to the computing system or device from another computing system or device or a memory storage device.

Examples of suitable memory storage systems include storage subsystem 124 which can include the operating system “kernel” layer and an application layer to enable the device to perform various functions, tasks, or roles. File storage subsystem 126 can provide persistent (non-volatile) storage for additional program and data files, and may include a hard disk drive, a floppy disk drive along with associated removable media, a compact digital read only memory (CD-ROM) drive, an optical drive, or removable media cartridges.

Memory subsystem 128 typically includes a number of memories including a main random access memory (RAM) 130 for storage of program instructions and data during program execution and a read only memory (ROM) 132 in which fixed instructions are stored. As used herein, a computer readable medium is intended to include the types of memory described above. Program embodiments as will be described further herein can be included with a computer readable medium and may also be provided using a carrier wave over a communications network such as the Internet, among others.

Bus subsystem 112 provides a mechanism for letting the various components and subsystems of computer system 110 communicate with each other as intended. Although bus subsystem 112 is shown schematically as a single bus, alternate embodiments of the bus subsystem 112 may utilize multiple busses.

Program embodiments according to the present invention can be stored in the memory subsystem 126, the file storage subsystem 128, and/or elsewhere in a distributed computing environment as the same will be known and understood by one of ordinary skill in the art. Due to the ever-changing nature of computers and networks, the description of computer system 110 depicted in FIG. 1, is intended only as one example of a computing environment suitable for implementing embodiments of the present invention. Many other configurations of computer system 110 are possible having more or less components than the computer system depicted in FIG. 1.

Computing networks can include multiple computing devices such as servers, desktop PCs, laptops, and workstations, among other peripheral devices, e.g., printers, facsimile devices, and scanners, networked together across a local area network (LAN) and/or wide area network (WAN). A LAN and/or WAN uses clients and servers that have network-enabled operating systems such as Windows, Mac, Linux, and UNIX. An example of a client includes a user's workstation. Clients and servers can be connected in a client/server relationship in which the servers hold programs and data that are shared by the clients in the computing network.

As mentioned above, the kernel layer of a computer system manages the set of processes that are running on the system by ensuring that each process is provided with processor and memory resources at the appropriate time. A process refers to a running program, or application, with input, output, and a state. The kernel provides a set of services that allow processes to interact with the kernel, to perform internal kernel functions, and to simplify the work of an application writer.

The kernel's set of services is expressed in a set of kernel modules. A module is a self contained set of instructions designed to handle particular tasks within a larger program. Kernel modules can be compiled and subsequently linked together to form the kernel. Similarly, other types of modules can be compiled and subsequently linked together to form other types of programs.

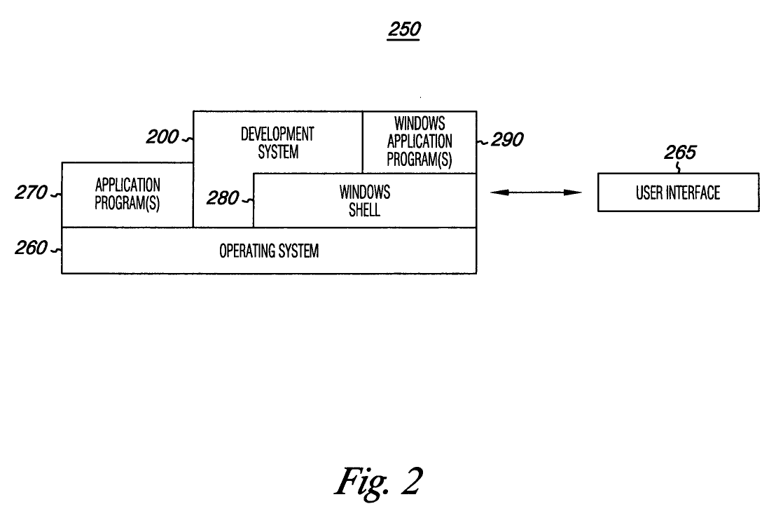

FIG. 2 is a block diagram embodiment of a software system 250 executable on the computer system such as shown in FIG. 1. The software system 250 illustrated in FIG. 2 can be provided to a computing system for controlling the operation of the computer system itself and/or another computing device within a network as described above. Software system 250, which can be stored in main memory, e.g., memory subsystem 126, includes a kernel or operating system layer 260 and a windows shell or interface 280. The operating system includes a number of linked kernel modules and can include the module embodiments discussed in more detail below. Programs are written in software code (i.e. computer executable instructions) by programmers for execution on computing devices and across computing networks.

One or more application programs, such as application programs 270 or windows applications programs 290, may be transferred from file storage subsystem 128 into main memory 126 for execution by the computing system and/or across a network as shown in FIG. 1. Operating system 260 and shell 280, as well as application software 270 and 290, communicate with a user through an interface 265 for receiving commands and data and displaying results and other useful information. As shown in the embodiment of FIG. 2, the development system 200 can include components which can interface to a computing system through a windows shell 280, as well as components which interface directly through the operating system 260. Development systems can be used offline, where the program being designed is not in use, or can be used online, where the program being designed is in use. This situation can be beneficial for systems that cannot have a large amount of downtime, or for updates to the system that do not require it to be offline during the update process.

By way of example, and not by way of limitation, the operating system 260 of the computing system, e.g., system 110 in FIG. 1, can include a UNIX, Linux, AIX, Windows, and/or Mac operating system, among others. The software system 250, including the development system 200, can be written in any suitable programming language, e.g., C, C++, Pascal, COBOL, Java, etc., as appropriate for interacting with a variety of software applications, including word processing, database, spreadsheet, text editors, and the like.

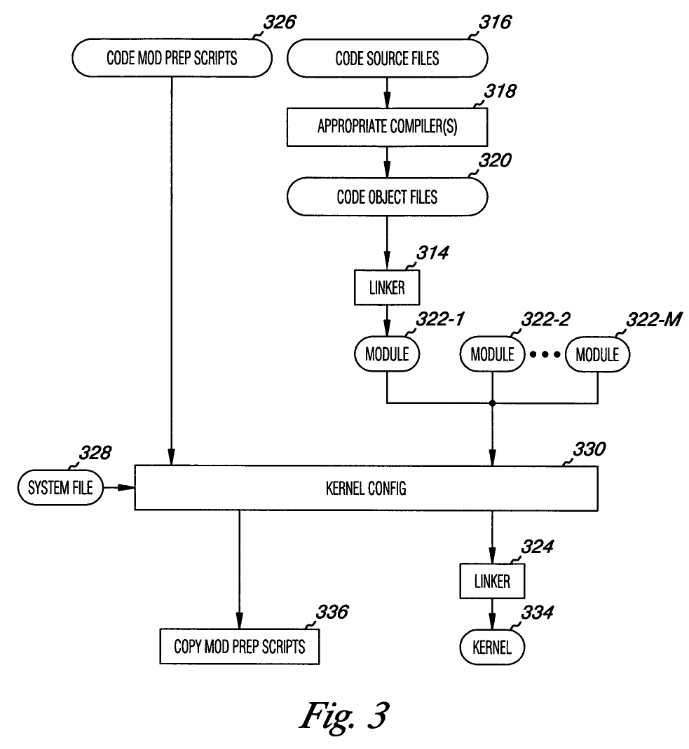

FIG. 3 is a block diagram illustrating an embodiment of a development system. One type of popular programming is modular programming which breaks down the design of a program into individual components (modules) that can be programmed and tested independently. FIG. 3 is discussed in relation to embodiments of the invention and their use with an exemplary modular programming process. As shown in the embodiment of FIG. 3, the development system, is provided with code source files shown as 316, i.e., source files which can be written in various high level programming languages.

As the reader will appreciate, a kernel can initially be built with a set of modules. Each module contains executable code and data to provide some service to the kernel. Each module has an associated set of data that describes the module's capabilities and characteristics.

FIG. 3 illustrates one mechanism for a program build process. FIG. 3 is a conceptual flow chart of a UNIX kernel build process. Embodiments, however, are not limited to a UNIX environment or a kernel build process. As illustrated in FIG. 3, source files, shown as 316, can be passed through appropriate compilers 318 to create code object files 320 to export to the linker utility 314. One of ordinary skill in the art will appreciate from reading the present disclosure that from the source code and other file and data resources an appropriate compiler “compiles” or generates object modules or files. For general background on the construction and operation of compilers, reference is made to Fischer et al., Crafting a Compiler with C, Benjamin/Cummings Publishing Company, Inc., 1991.

Upon successful creation of object files, the linker 314 “links” or combines the object files, e.g., 320 with standard libraries (e.g., graphics, I/O routines, startup code, and the like) to generate executable program modules, 322-1, 322-2, . . . , 322-N. As one of ordinary skill in the art will appreciate, a linker 314 is a tool which generally takes object files as input and builds binary code out of them, i.e. machine language.

The process illustrated in FIG. 3 centers around two invocations of the linker, 314 and 324. The first invocation is used to link together a module. This happens once for each module. The second invocation is used to combine modules together to make a kernel.

The discussion above centers around the first invocation of a linker, i.e., linker 314. As stated above, this first invocation is used to link together modules, i.e., independent code in machine language, shown as 322-1, 322-2, . . . , 322-M. The designator “M” is used to illustrate that a number of such modules can be created, however, the illustration of a number of modules 322, should not be viewed as limiting the quantity of the other components shown and described herein.

In one example of the linking of modules to form an operating system kernel the operating system kernel is a collection of around 350 such modules. The process up through and including the invocation of linker 314 is performed in the development environment.

As shown in the example illustration of FIG. 3, once all of the modules 322-1, 322-2, . . . , 322-M have been built in this fashion, a second invocation of a linker 324 is used to join modules together to make a program, e.g., an operating system kernel.

This part of the process may be performed in either the development environment or the runtime environment, or a combination of the two environments. For example, an operating system can be initially configured in the development environment or the runtime environment. In some instances, modules can be added or removed in the either the development or runtime environment.

As illustrated, the second invocation of a linker 324 receives instructions 330 from a kernel configuration tool 330, which reads the modules, 322-1, 322-2, . . . , 322-M, to find out what modules are available. The kernel configuration tool 330 can allow a system administrator to specify tunable variables, i.e., values that control the behavior of the modules, 322-1, 322-2, . . . , 322-M. Such values can be contained in computing system files 328. The “system file” 328 also specifies which modules are to be used to create the software application, e.g., operating system kernel.

Also shown in FIG. 3 are the creation of module preparation scripts for use in preparing a computing system or device for a change in status of a particular module. In block 326, one or more module preparation scripts are created. A module preparation script can be used before, during, and/or after the loading or unloading of a particular module or a set of modules.

Program instructions can be used to “load” or “unload” various modules into the computing program, e.g., operating system kernel. According to various embodiments, as shown by the example of FIG. 3, program instructions use module preparation script(s), such as scripts that have been saved in memory, to check to see that the computing system has all of the information that will be used to load or unload a module. In FIG. 3, the module preparation scripts can be created (e.g., code mod preparation scripts 326) by the developer when the developer creates the module. However, the embodiments of the invention are not so limited. The module preps scripts can be copied to a staging directory on a computing device or system for use in loading and unloading modules to which the particular module preps scripts are associated, as is illustrated at 336.

Information that will be used to load or unload a module can include software application settings (e.g., tunables), software application availability, and hardware availability, and the like. For example, the module may have to have tunable data configured in a particular way. In some embodiments, the program instructions can check to see that these tunables are configured correctly.

The program instructions can also provide the ability to edit the tunables automatically or through user input. In this way, if the computing system or device is not correctly configured, the configuration can be changed to prepare the computing system or device for the loading or unloading process. As stated above, embodiments can also include program instructions to check to see if hardware or software, to be used by the module, is available, e.g., installed and setup on the computing device or system.

Module preparation scripts can be provided for each module to be loaded or unloaded. In some cases, several modules are to be loaded and/or unloaded as a group. In some instances, the module preparation scripts for each of the modules in the group can be executed together such that the computing system or device is prepared for the loading or unloading or all of the modules in the group.

In various embodiments, the group can have a module preparation scripts for the loading/unloading of the entire group. This “group” module preparation script can be in addition to the module preparation scripts for each module or can be provided instead of the individual module preparation scripts.

In some embodiments, if the resources of the computing device or system are not capable of being properly configured for a load or unload, program instructions can execute to interrupt the loading or unloading process. In such instances, the computing device or system can be returned to normal operation with out the module(s) being loaded or unloaded or program instructions can be executed to reverse the loading or unloading process that has already occurred as part of the aborted load or unload process. This can include the reversal of modules, within a group of modules being loaded or unloaded, that were loaded or unloaded successfully.

In some embodiments, guidance can be provided to a user of the computer system or device informing them of the reasons for interrupting the loading process. In this way, the user can understand why the process was interrupted and may be able to resolve the issue(s) that caused the interruption to occur.

In various embodiments, the program instructions can automatically, or with the aid of the user, change the configuration of the computing system or device. Program instructions can also be provided to stop the load or unload process if the configuration of the computing system or device is not suitable in one or more respects.

In some embodiments, this interruption of the process can take place before any changes have been made to the computing system or device. However, in some cases, program instructions can be provided that can reverse the changes made if the load or unload process is interrupted. In such embodiments, this allows for the computing system or device to be retuned to its pre-process configuration until the appropriate changes can be made to prepare the computing system or device for the load or unload process. In various embodiments, the reasons for the interruption of the load or unload process can be logged and/or can be reported to the user.

Additionally, in some embodiments, the program instructions can execute to check the resources that are used in the entire load or unload process. In this manner, the user can remedy all potential causes of interruption of the load or unload process and not just the one that initiated the interruption or those prior to and including the one that initiated the interruption.

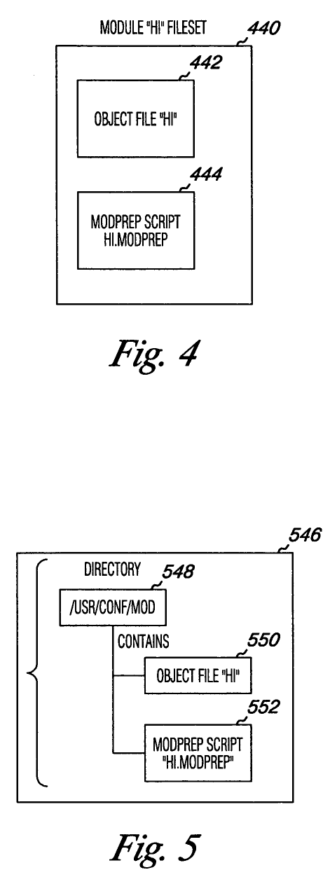

FIG. 4 is an illustration of a development environment module embodiment of the present invention. In this embodiment, a module fileset 440 includes two files, an object file 442 named “HI” and a module preparation script 444 named “HI.MODPREP”. In various embodiments, the fileset 440 can be sent to a computing device or system for use. The computing device or system can then either automatically, e.g., through program instructions on the computing device or system or sent with the fileset 440, or manually, e.g., through user input, position the files individually (i.e., 442 and 444) or the fileset 440 in its entirety, in the computing system or device. FIG. 5 shows one such example of the positioning of the fileset 440.

FIG. 5 is an illustration of a target environment module embodiment of the present invention. In FIG. 5, the contents of the module “HI” fileset (i.e., object file “HI” 550 and module preparation script “HI.MODPREP”) are positioned within memory (e.g., external memory such as a hard drive) of the computing device or system 546 (i.e., the target environment) and are addressed to directory location /usr/conf/mod shown at 548.

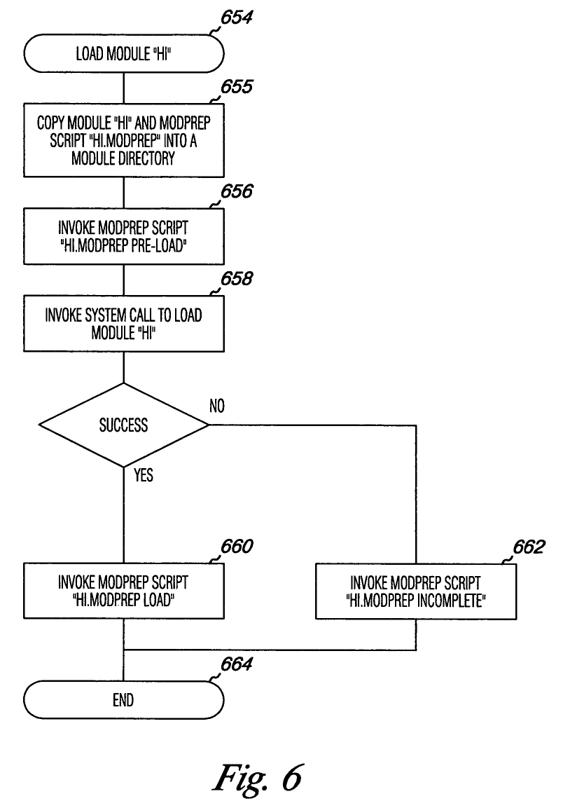

FIG. 6 is an example of a module and module preparation script interaction. The embodiment of FIG. 6 is representative of the use of a module preparation script at the beginning or pre-load phase of a load process. In the embodiment shown in FIG. 6, an instruction to load the module “HI” is received at block 654. As described above, this can be initiated automatically or by a user.

In block 655, the module “HI” and module preparation script “HI.MODPREP” are copied into a module directory. In this way, the module preparation script(s) corresponding to a module are available when they are called. In various embodiments, the module preparation scripts can be located within the same directory structure as the particular module. In some embodiments, the one or more module preparation scripts associated with a particular module can be located with the module in the same sub-directory.

A module preparation script instruction set “HI.MODPREP PRE-LOAD” within HI.MODPREP is initiated at block 656 to check the system to see that the resources to be used in the load process are available. In various embodiments, the process can change the configuration of the computing system or device automatically or manually, or can interrupt the load process during this checking procedure, as discussed above.

In the embodiment of FIG. 6, the loading of module “HI” can be initiated by a system call invoking the loading of module “HI”, at block 658. In the embodiment shown, the loading process can be either successful or unsuccessful.

In some embodiments, such as that shown in FIG. 6, another module preparation script instruction set “HI.MODPREP LOAD” within HI.MODPREP is initiated at block 660 to check the system to see that the resources to be used by the module are available. Program instructions can also be used to clean up from the loading process. In such embodiments, the module preparation script can change the configuration, delete files, move files, change file addresses, and other such cleanup tasks.

Module preparation scripts can also be used to clean up the computing system or device in embodiments where a module preparation script is used in an unload process. In block 662, if the module loading/unloading process is unsuccessful the module preparation script can include an instruction set HI.MODPREP INCOMPLETE which includes instructions for reversing the loading/unloading process. The reversing of the loading/unloading process can include module functions, module preparation functions, and the like. Additionally, in some embodiments, the program instructions for reversing the loading/unloading process can be used to reverse more than the loading/unloading of a single module. And, although shown as module preparation scripts instruction sets in the embodiment of FIG. 6, the functions of blocks 656 and 660 can be provided by a number of module preparation scripts in some embodiments.

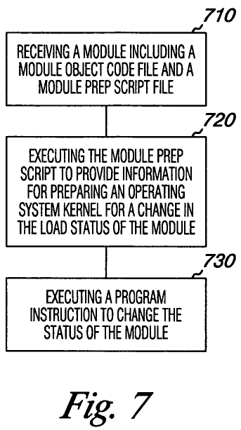

FIG. 7 illustrates a method embodiment for handling a change in module load status. As one of ordinary skill in the art will understand, the embodiments can be performed by software/firmware (e.g., computer executable instructions) operable on the devices shown herein or otherwise. The embodiments of the invention, however, are not limited to any particular operating environment or to software written in a particular programming language. Software, application modules, and/or computer executable instructions, suitable for carrying out embodiments of the present invention, can be resident in one or more devices or locations or in several locations.

Unless explicitly stated, the method embodiments described herein are not constrained to a particular order or sequence. Additionally, some of the described method embodiments or elements thereof can occur or be performed at the same point in time.

In block 710, the method of FIG. 7 includes receiving a module including a module object code file and a module preparation script file. The method of FIG. 7 also includes executing the module preparation script to provide information for preparing an operating system kernel for a change in the load status of the module, at block 720.

In block 730, the method also includes executing a program instruction to change the status of the module. Executing a program instruction to initiate the changing of the status of the module can be accomplished in various manners. For example, the program instruction can be associated with a kernel command. For example, “load” and “unload” kernel commands are two suitable command words or symbols that can be associated with. In this way, the module preparation script can be implemented as part of another function that is to be performed by the administrator or user.

In such instances, the module preparation script can be designed to be transparent to the user or administrator. For instance, when an administrator requests the loading of the module by inputting the “load” command word, the program instructions can execute to initiate the module preparation script to prepare the operating system for a module load status change, in this example, the loading of the module.

In some embodiments, the execution of the module preparation script can occur after the execution of the module and wherein the module preparation script for preparing the operating system kernel for a change in the load status of the module. The module preparation script can be used to add, check the status of, and/or remove various hardware and/or software components on a computing device or system. For example, the module preparation script can be designed to remove data from the operating system kernel that was associated with one or more modules that are being unloaded.

Executing the module preparation script to provide information for preparing the operating system kernel for a change in the load status of the module can include occur in various ways. For example, at least a portion of the module preparation script can be executed at one of the following time periods: pre-load, post-load, pre-unload, and post-unload. In various embodiments, a separate module preparation script can be provided for each time period in which a module preparation script is to be used. In some embodiments, a module preparation script can include activities that occur during more then one time period, e.g., pre-load and post-load in one module preparation script file. Additionally, preparing for a change in load status includes preparing for a load or unload to begin or complete. Preparing for a change in load status also includes reversing a load or unload operation that was not completed.

In various embodiments, the method can also include designing a module preparation script to provide information for preparing the operating system kernel for a change in the load status of the module and bundling the module preparation script with the module object data file to execute in conjunction with a process that changes the module load status. Methods can also include communicating the status of a load status change process to a display device.

In some embodiments, it may be beneficial to be able to reverse the loading or unloading process if the process is not fully completed. In such instances, the method can include reversing the execution of the module preparation script if the module load status change is not fully completed. Reversing the execution of the module preparation script can include reversing the module preparation script from a point at which the execution of the module preparation script stopped. In this way, only the activities that have been completed by the module preparation script are reversed. In some embodiments, modules can be loaded or unloaded together and, in such instances, it may be necessary to reverse the loading or unloading of a number of modules that depend on one another. In such cases, one or more module preparation scripts can be used to reverse a number of modules.

Although specific embodiments have been illustrated and described herein, those of ordinary skill in the art will appreciate that any arrangement that can achieve the same techniques can be substituted for the specific embodiments shown. This disclosure is intended to cover any and all adaptations or variations of various embodiments of the invention.

It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes any other applications in which the above structures and methods are used.

Therefore, the scope of various embodiments of the invention should be determined with reference to the appended claims, along with the full range of equivalents to which such claims are entitled. In the foregoing Detailed Description, various features are grouped together in a single embodiment for the purpose of streamlining the disclosure.

This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A module, comprising:
a module object file for implementing a function in a program application; and
a module preparation script file associated with the module object file to provide information to prepare the program application for a change in the load status of the module.

2. The module of claim 1, wherein the module can be used in a runtime environment as part of an initial program application build process.

3. The module of claim 1, wherein the module can be used in a runtime environment as part of a module status change process occurring after an initial program application build process has been performed.

4. The module of claim 1, wherein the information provided includes data for use in loading a module.

5. The module of claim 1, wherein the information includes identification of whether data to be used in loading a module is available.

6. The module of claim 1, wherein the data includes program instructions to be used in loading a module.

7. The module of claim 1, wherein the module object file and the module preparation script are bundled together to be provided to and used by an operating system administrator.

8. A module load status change tool, comprising:
a processor;
a memory coupled to the processor; and
program instructions provided to the memory and executable by the processor including:
a module preparation script associated with a module; and
wherein the module preparation script provides information to prepare an operating system for a module load status change.

9. The module load status change tool of claim 8, wherein the information provided includes hardware information.

10. The module load status change tool of claim 9, wherein hardware information includes identification of whether hardware to be used in loading a module is available.

11. The module load status change tool of claim 10, wherein the information provided includes object data for use in loading a module.

12. The module load status change tool of claim 8, wherein the information includes identification of whether an object file to be used in loading a module is available.

13. The module load status change tool of claim 8, wherein the information includes identification of whether another module to be used with the module to be loaded is available.

14. A kernel configuration tool, comprising:
a processor;
a memory coupled to the processor; and
program instructions provided to the memory and executable by the processor including:
a module for implementing a function in an operating system kernel; and
means for providing information at runtime to prepare the operating system kernel for a change in the load status of the module.

15. The kernel configuration tool of claim 14, wherein the means for providing information includes a module preparation script to be implemented before and after the change in the load status of the module.

16. The kernel configuration tool of claim 15, wherein the means for providing information includes a different module preparation script for implementation before and after the change in the load status of the module.

17. The kernel configuration tool of claim 14, wherein the means for providing information includes a module preparation script to be implemented before and after the change in the load status of the module from an unloaded status to a loaded status.

18. The kernel configuration tool of claim 14, wherein the means for providing information includes a module preparation script to be implemented before and after the change in the load status of the module from a loaded status to an unloaded status.

19. The kernel configuration tool of claim 14, wherein the means for providing information includes a module preparation script that is to be implemented at runtime of a load status change process.

20. A method for handling a change in module load status, comprising:
receiving a module including a module object code file and a module preparation script file;
executing the module preparation script to provide information for preparing an operating system kernel for a change in the load status of the module; and
executing a program instruction to change the status of the module.

21. The method of claim 20, further including designing a module preparation script to provide information for preparing the operating system kernel for a change in the load status of the module and bundling the module preparation script with the module object data file to execute in conjunction with a process that changes the module load status.

22. The method of claim 20, wherein the execution of the module preparation script occurs after the execution of the module and wherein the module preparation script for preparing the operating system kernel for a change in the load status of the module.

23. The method of claim 22, wherein the module preparation script removes data from the operating system kernel that was associated with a module that is being unloaded.

24. The method of claim 20, wherein executing a program instruction to initiate the changing of the status of the module includes associating the program instruction to a kernel command.

25. The method of claim 20, wherein executing a program instruction to initiate the changing of the status of the module includes associating the program instruction to a “load” kernel command.

26. The method of claim 20, wherein executing a program instruction to initiate the changing of the status of the module includes associating the program instruction to a “unload” kernel command.

27. A computer readable medium having a program to cause a device to perform a method, comprising:
receiving a module including a module object code file and a module preparation script file;
executing the module preparation script to provide information for preparing an operating system kernel for a change in the load status of the module; and
executing a program instruction to change the status of the module.

28. The medium of claim 27, wherein executing the module preparation script to provide information for preparing the operating system kernel for a change in the load status of the module includes executing at least a portion of the module preparation script at one of the following time periods: pre-load, post-load, pre-unload, and post-unload.

29. The medium of claim 27, wherein the method further includes communicating the status of a load status change process to a display device.

30. The medium of claim 27, wherein the method further includes reversing the execution of the module preparation script if the module load status change is not fully completed.

31. The medium of claim 30, wherein reversing the execution of the module preparation script includes reversing the module preparation script from a point at which the execution of the module preparation script stopped.

32. The medium of claim 27, wherein the method further includes checking a configuration of the operating system kernel and interrupting the change in the load status if the configuration is not suitable for changing the status.

33. The medium of claim 32, wherein the method further includes reversing the execution of the module preparation script if the change in load status is interrupted.

34. The medium of claim 32, wherein the method further includes reversing the change in load status if the change in load status is interrupted.

35. The medium of claim 32, wherein receiving a module including a module object code file and a module preparation script file includes receiving two or more modules each including a module object file and a module preparation script file.

36. The medium of claim 32, wherein receiving a module including a module object code file and a module preparation script file includes receiving two or more modules, each including a module object file, and wherein the module preparation script file is a group module preparation script file.
